(19) United States
(12) Patent Application Publication
(10) Pub. No.: US 2007/0188537 A1
(43) Pub. Date: Aug. 16, 2007

(54) Normalization method of ink drops to ensure uniformity of amount of ink ejected from nozzles of inkjet head

(75) Inventors: Wou-sik Kim, Suwon-si (KR); Seong-iin Kim, Seongnam-si (KR); Sung-woong Kim, Suwon-si (KR); Kye-si Kwon, Seoul (KR); Sang-il Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/585,254

(22) Filed: Oct. 24, 2006

(30) Foreign Application Priority Data
Feb. 16, 2006 (KR) 2006-15161

(51) Int. Cl. B41J 29/393

(52) U.S. Cl. 347/19

(57) ABSTRACT

A normalization method of ink drops to ensure uniformity of an amount of ink drops ejected from nozzles of an inkjet head. The normalization method including ejecting a predetermined number of ink drops from the nozzles into pixels while changing a voltage applied to the nozzles, measuring the mean thicknesses of ink layers formed in the pixels, and setting a target thickness of the ink layers and applying a voltage corresponding to the target thickness to each of the nozzles.

### CROSS-REFERENCE TO RELATED APPLICATIONS

This application claims priority under 35 U.S.C. §119(a) from Korean Patent Application No. 10-2006-0015161, filed on Feb. 16, 2006, in the Korean Intellectual Property Office, the disclosure of which is incorporated herein in its entirety by reference.

### BACKGROUND OF THE INVENTION

1. Field of the Invention

The present general inventive concept relates to a normalization method of ink drops to ensure uniformity of an amount of ink ejected from nozzles of an inkjet head.

2. Description of the Related Art

Conventionally, cathode ray tube (CRT) monitors have been used to display information from TVs and computers. Recently, to provide larger screen sizes, flat display devices such as liquid crystal displays (LCDs), plasma display panels (PDPs), organic electroluminescent (EL) displays, light emitting diode (LED) displays, and field emission displays (FEDs) have been used. LCDs are the usual choice for computer monitors and laptop computers because of their low power consumption.

An LCD includes a color filter for forming an image of desired colors by passing white light modulated by a liquid crystal layer. The color filter has a structure in which a plurality of red (R), green (G), and blue (B) pixels are arranged in a pattern on a transparent base plate. Color filters can be manufactured by dyeing, pigment dispersion, printing, and electrodeposition. However, since these methods need a separate process for each color of pixel, process efficiency is low and manufacturing cost is high.

Thus, methods of manufacturing color filters by inkjet printing have recently been suggested, to simplify the manufacturing process and reduce the manufacturing cost. By the inkjet method, the color filters are manufactured by discharging colored ink drops, for example R, G, and B colored drops, through nozzles of an inkjet head into pixels on a base plate.

FIGS. 1 and 2 are conceptual diagrams illustrating a conventional method of manufacturing color filters using an inkjet method. If colored ink drops 60 are ejected from nozzles 55 of an inkjet head 50 into pixels 22 partitioned by a black matrix 20 on a base plate 10 as illustrated in FIG. 1, colored ink layers 65 are formed in the pixels 22 as illustrated in FIG. 2. However, the nozzles 55 of the inkjet head 50 can have different ejection characteristics, causing different amounts of ink to be ejected from the nozzles 55. Accordingly, a thickness of the ink layers 65 can vary from pixel to pixel as illustrated in FIG. 2. This non-uniform thickness of the color filter causes significant degradation of color quality.

Thus, various methods for normalizing the amount of ejected ink have recently been developed, to ensure a uniform thickness of the color filter. One method is to normalize a speed of the ink drops. However, the speed normalization method does not necessarily normalize the amount of ink. Another method is to normalize a mass of the ink drops. However, the mass normalization method involves measuring a number of ink drops, which is time consuming and may generate a measurement error. Another method is to normalize volumes of the ink drops. However, this is difficult when the shapes of the ink drops are irregular.

### SUMMARY OF THE INVENTION

The present general inventive concept provides a method of normalizing the amount of ink ejected from nozzles of an inkjet head to ensure a uniform thickness of a color filter.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a normalization method of ink drops to ensure uniformity of an amount of ink ejected from nozzles of an inkjet head, the normalization method including ejecting a predetermined number of ink drops from the nozzles into pixels according to a first voltage applied to the nozzles, measuring mean thicknesses of ink layers formed in the pixels, and setting a target thickness of the ink layers and applying a second voltage corresponding to the target thickness to each of the nozzles.

The mean thicknesses of the ink layers may be measured using scanning white light interferometry (SWLI) or a stylus type surface profiler.

The SWLI may measure the mean thicknesses of the ink layers using a mask in which areas having the same size as the pixels are formed.

The first voltage may vary according to a position of the pixels.

The nozzles may move with respect to the pixels in a direction, and the first voltage may vary according to the position of the pixels in the direction.

The pixels may include a plurality of rows of pixels, and the ejecting of the predetermined number of ink drops may include ejecting the predetermined number of ink drops in corresponding rows of pixels according to the first voltage.

The first voltage may include a plurality of voltages, and the ejecting of the predetermined number of ink drops may include ejecting the predetermined number of ink drops in the corresponding rows of pixels according to corresponding ones of the plurality of first voltages.

The measuring mean thicknesses of ink layers may include measuring the mean thicknesses of respective rows of the pixels, and the applying of the second voltage may include applying the second voltage according to the respective thicknesses.

The normalization method may further include ejecting a second predetermined number of ink drops from the nozzles into the pixels according to the second voltage such that a uniform thickness is formed in the respective pixels.

The normalization method may further include ejecting an amount of ink drops from the nozzles according to the second voltage.

The foregoing and/or other aspects and utilities of the present general inventive concept are also achieved by providing a normalization method of ink drops to ensure uniformity of an amount of ink ejected from nozzles of an inkjet head, the normalization method including ejecting a predetermined number of ink drops from the nozzles onto predetermined locations on a base plate according to a first voltage applied to the nozzles, measuring mean thicknesses of ink layers formed on the base plate, and setting a target thickness of the ink layers and applying a second voltage corresponding to the target thickness to each of the nozzles.

The foregoing and/or other aspects and utilities of the present general inventive concept are also achieved by providing a computer-readable recording medium having embodied thereon a computer program to execute a normalization method of ink drops to ensure uniformity of an amount of ink ejected from nozzles of an inkjet head, the normalization method including ejecting a predetermined number of ink drops from the nozzles into pixels according to a first voltage applied to the nozzles, measuring mean thicknesses of ink layers formed in the pixels, and setting a target thickness of the ink layers and applying a second voltage corresponding to the target thickness to each of the nozzles.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 and 2 are conceptual diagrams illustrating a conventional method of manufacturing color filters using an inkjet method;

FIG. 3 is a conceptual diagram illustrating a normalization method of ink drops according to an embodiment of the present general inventive concept and illustrating a plurality of nozzles included in an inkjet head and pixels into which ink drops are ejected from the nozzles;

FIG. 4 is a photograph illustrating ink layers formed in pixels by ejecting ink drops from the nozzles of the inkjet head illustrated in FIG. 3;

FIG. 5 illustrates a thickness distribution of ink layers on a line A-A′ of FIG. 4 measured by scanning white light interferometry (SWLI);

FIG. 6 is a graph illustrating the mean thicknesses of ink layers formed in pixels according to a voltage applied to the nozzles of the inkjet head illustrated in FIG. 3; and

FIG. 7 is a conceptual diagram illustrating a normalization method of ink drops according to another embodiment of the present general inventive concept and illustrating a plurality of nozzles included in an inkjet head and ink layers formed on a base plate by the nozzles.

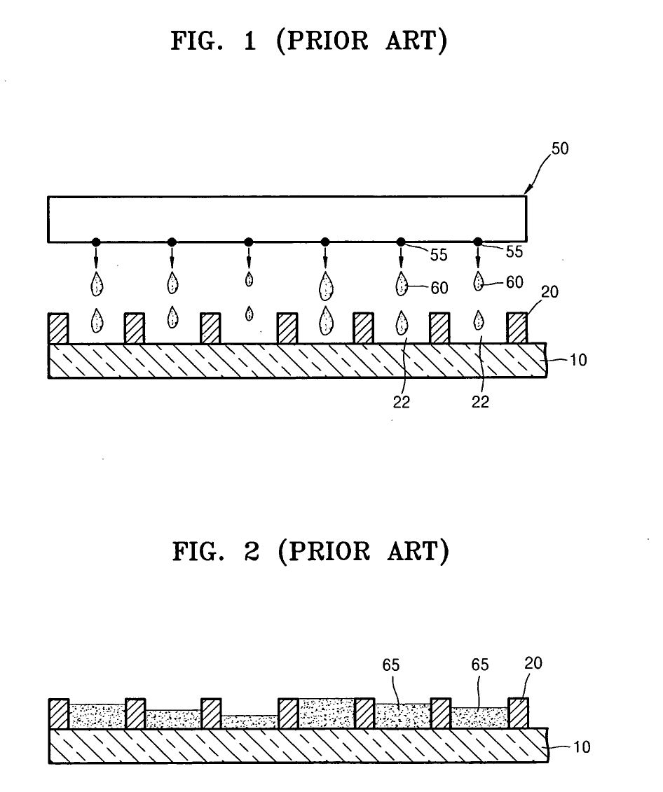

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

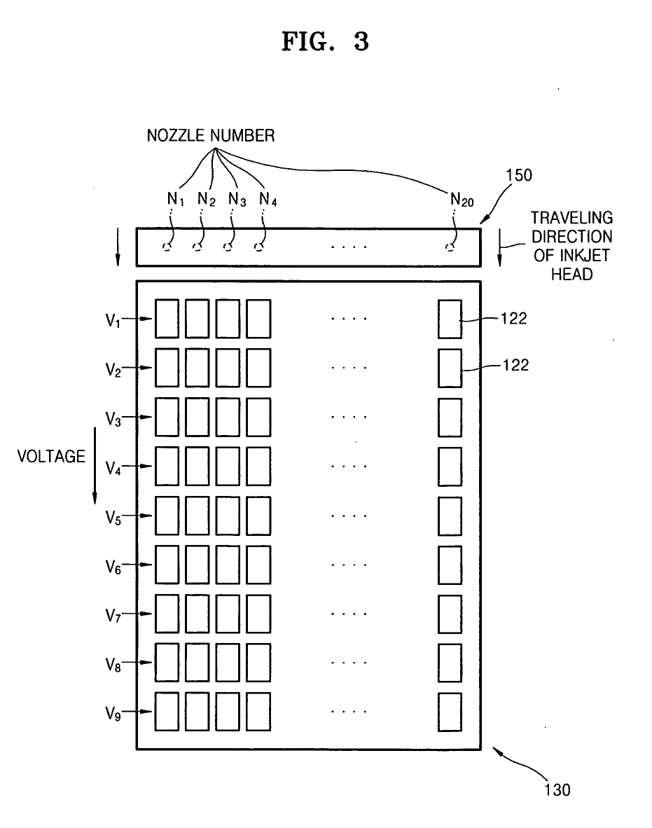

FIG. 3 is a conceptual diagram illustrating a normalization method of ink drops according to an embodiment of the present general inventive concept and illustrating a plurality of nozzles included in an inkjet head 150 and a plurality of pixels 122 into which ink drops are ejected from the nozzles. The normalization method may be used to manufacture a color filter 130 using the inkjet head 150.

Referring to FIG. 3, the inkjet head 150 includes the plurality of nozzles to eject ink drops. The inkjet head 150 as illustrated in FIG. 3 includes 20 nozzles numbered N₁, N₂, N₃, N₄, . . . N₂₀. On the color filter 130, the pixels 122 may be formed in a plurality of pixel rows, for example, 9 pixel rows as illustrated in FIG. 3, and a plurality of pixel columns corresponding to the number of nozzles that make up each pixel row, for example, 20 pixel columns as illustrated in FIG. 3.

A predetermined number of ink drops may be ejected into each of the pixels 122 on the color filter 130 from the nozzles, according to a voltage applied to the nozzles. The voltage may be changed to eject the predetermined number of ink drops. For instance, 5 ink drops are ejected into each of the pixels 122 in a first pixel row from the nozzles by applying a voltage V₁ to the nozzles of the inkjet head 150. Accordingly, ink layers are formed in the pixels 122 of the first pixel row by the ink drops ejected from the nozzles to which the voltage V₁ is applied. Then, the inkjet head 150 is moved, and the same number of ink drops are ejected into each of the pixels 122 of a second pixel row from the nozzles by applying a voltage V₂ to the nozzles. Accordingly, ink layers are formed in the pixels 122 of the second pixel row by the ink drops ejected from the nozzles to which the voltage V₂ is applied. Likewise, voltages V₃, V₄, . . . , V₉ are sequentially applied to the nozzles as the inkjet head is moved over the respective pixel rows, and the same number of ink drops are ejected into the pixels 122 of each of the remaining rows from the nozzles to which the voltages V₃, V₄, . . . , V₉ are applied. Accordingly, ink layers of thicknesses corresponding to each applied voltage V₃, V₄, . . . , V₉ are formed in the pixels 122. While the color filter 130 illustrated in FIG. 3 consists of 9 pixel rows organized into 20 pixel columns, the present general invention concept is not limited thereto and the number of nozzles, the number of pixel rows, and the number of ink drops ejected from the nozzles can be changed as necessary.

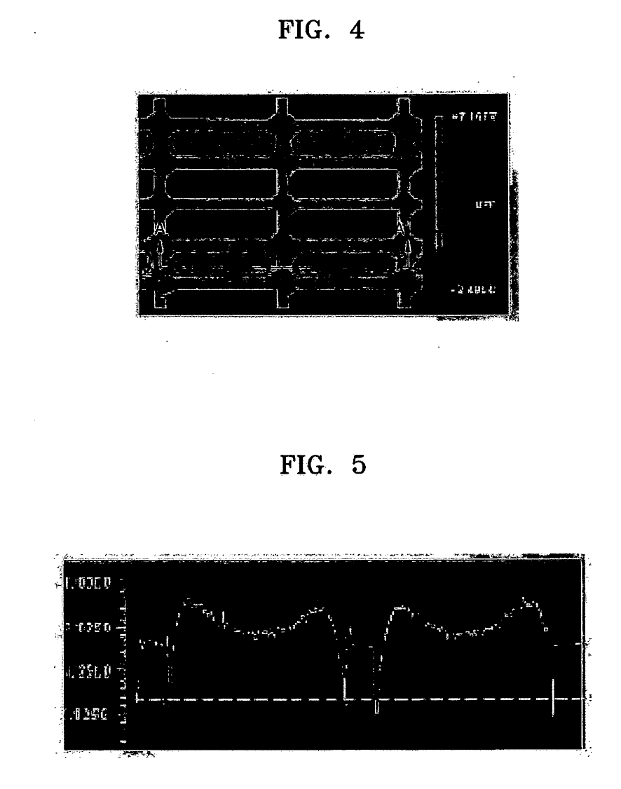

As described above, when the predetermined number of ink drops are ejected from the nozzles according to the voltage applied to the nozzles, ink layers corresponding to the each nozzles and each applied voltages are formed in the pixels 122 of the color filter 130. FIG. 4 is a photograph illustrating ink layers formed in the pixels 122 by ejecting the ink drops from the nozzles of the inkjet head 150.

Mean thicknesses of the ink layers formed in the pixels 122 on the color filter 130 can be measured. The mean thicknesses of the ink layers can be quickly measured by scanning white light interferometry (SWLI). For example, SWLI can be used to measure the mean thicknesses of the ink layers using a mask including measuring areas. The measuring areas have the same shape and size as the pixels 122 on the color filter 130. FIG. 5 illustrates thickness distribution of the ink layers on a line A-A′ of FIG. 4 measured by SWLI. The mean thicknesses of the ink layers can be measured using the measured thickness distribution. The mean thicknesses of the ink layers can also be measured using a stylus type surface profiler, which measures surface characteristics according to a vertical movement of a stylus in response to irregularities of a surface of a material, and is mainly used to measure thin film thicknesses. However, the stylus type surface profiler needs a longer measuring time.

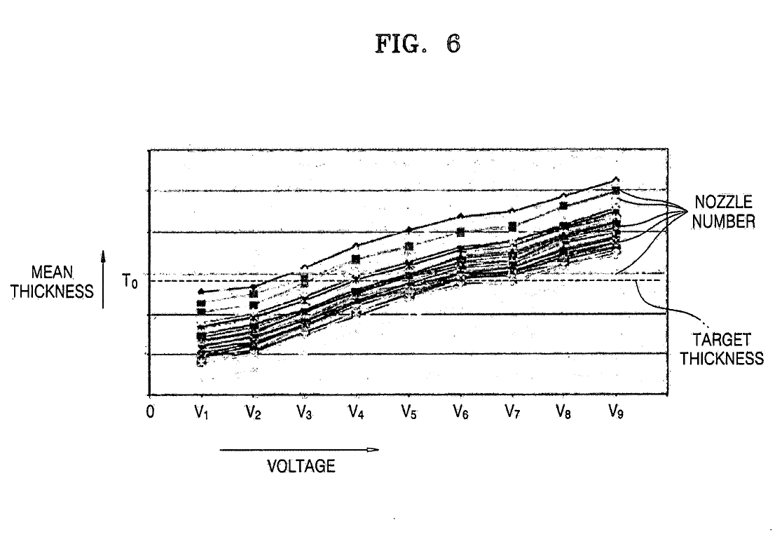

FIG. 6 is a graph illustrating the mean thicknesses of the ink layers formed in the pixels 122 on the color filter 130. Referring to FIG. 6, the mean thickness of ink layers formed by different nozzles at different voltages can be obtained. Likewise, all the mean thicknesses of the ink layers formed in the pixels 122 on the color filter 130 can be measured. Then, a target thickness Tₒ of the ink layers to be formed in the pixels 122 is set. Accordingly, a voltage applied to each nozzle to obtain the target thickness Tₒ of the ink layer is determined. By applying the determined voltages to the nozzles, equal amounts of ink can be ejected from the nozzles. That is, if a color filter is manufactured by applying voltages corresponding to the target thickness of ink layers to nozzles of an inkjet head, ink layers of equal thickness are formed in all pixels of the color filter. If no voltage can achieve the target thickness Tₒ of the ink layer for a nozzle, ink layers having the same thickness as ink layers formed by the other nozzles can be formed by adjusting the number of ink drops ejected from the nozzle and/or the voltage of the nozzle.

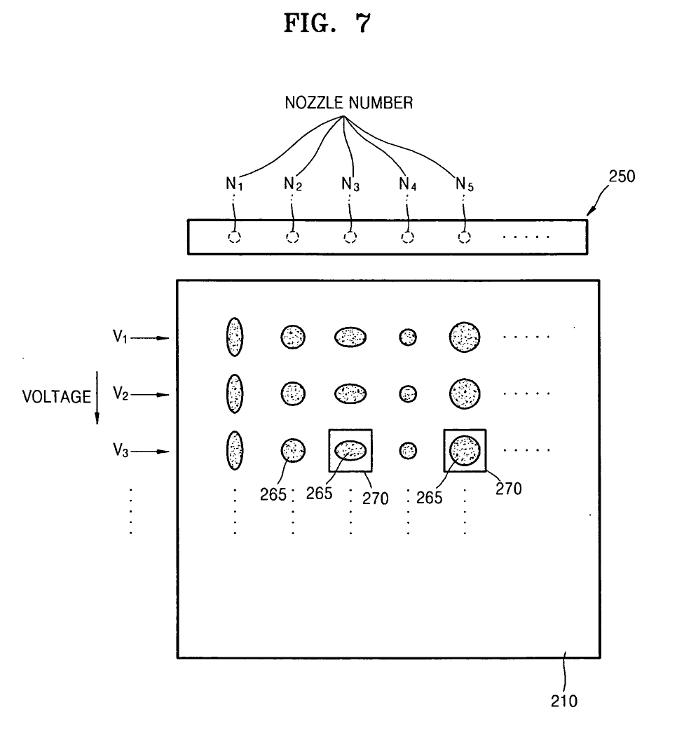

FIG. 7 is a conceptual diagram illustrating a normalization method of ink drops according to another embodiment of the present general inventive concept and illustrating a plurality of nozzles included in an inkjet head 250 and ink layers 265 formed on a base plate 210 by the nozzles. For brevity and conciseness only parts differing from the previous embodiment illustrated in FIG. 2 will be described.

Referring to FIG. 7, a predetermined number of ink drops are ejected onto predetermined locations on the base plate 210 from the nozzles according to a voltage applied to the nozzles of the inkjet head 250. The voltage may be changed to eject the predetermined number of ink drops from the nozzles. The base plate 210 can be a glass base plate having a flat surface, a silicon base plate having a flat surface, or other similar substrate. Referring to FIG. 7, the plurality of nozzles are numbered N₁, N₂, N₃, N₄, N₅, . . . . The predetermined number of ink drops are ejected from the nozzles onto the base plate 210 to constitute a first row of ink layers by applying the voltage V₁ to the nozzles of the inkjet head 250. Accordingly, ink layers 265 are formed on the base plate 210 by the ink drops ejected from the nozzles to which the voltage V₁ is applied. Then, after moving the inkjet head 250, the same number of ink drops are ejected from the nozzles onto the base plate 210 to constitute a second row of ink layers by applying a voltage V₂ to the nozzles. Accordingly, ink layers 265 are formed on the base plate 210 by the ink drops ejected from the nozzles to which the voltage V₂ is applied. Likewise, voltages V₃, V₄, V₅, . . . are sequentially applied to the nozzles as the inkjet head is moved, and the same number of ink drops are ejected from the nozzles onto the base plate 210 to form subsequent rows of ink layers 265 by applying each of the voltages V₃, V₄, V₅, . . . . Accordingly, ink layers 265 corresponding to the voltages V₃, V₄, V₅, . . . applied to the nozzles are formed on the base plate 210. The number of nozzles, the number of rows, and the number of ink drops ejected from the nozzles can be changed as necessary. As described above, when a predetermined number of ink drops are ejected from the nozzles while changing the voltage applied to the nozzles of the inkjet head 250, ink layers 265 having predetermined shapes corresponding to nozzle numbers and applied voltages are formed on the base plate 210.

The mean thicknesses of the ink layers 265 formed on the base plate 210 can be measured. For example, SWLI can be used to measure the mean thicknesses of the ink layers 265 using a mask including measuring areas 270. The mean thickness of the ink layers 265 corresponding to each nozzle can be measured by measuring the mean thickness of the ink layers 265 in each measuring area 270. To do this, the measuring areas 270 are formed a little larger than the ink layers 265. The mean thicknesses of the ink layers 265 also can be measured using the stylus type surface profiler. Measuring the mean thicknesses of the ink layers 265 formed on the base plate 210 gives a result similar to that illustrated in FIG. 6.

Once a target thickness of the ink layers 265 to be formed on the base plate 210 is set, the voltage to be applied to each nozzle to obtain the target thickness of the ink layers 265 can be determined. By applying the determined voltages to the nozzles, equal amounts of ink can be ejected from the nozzles, thereby producing color filters of uniform thickness.

As described above, and according to the present general inventive concept, by normalizing the mean thicknesses of ink layers formed by ink drops ejected from nozzles of an inkjet head, the voltage applied to each nozzle can be adjusted to ensure a uniform amount of ink is ejected from the nozzles. Since this normalization method of mean thicknesses is performed by directly measuring the thicknesses of ink layers, the normalization method of mean thicknesses may give better results than the conventional normalization methods.

Although a method of normalizing the amount of ink ejected from nozzles of an inkjet head to achieve a uniform thickness of a color filter has been described, the present general inventive concept can also be applied to a general inkjet printing method, and to inkjet printing methods for forming an organic light emitting layer of an organic LED (OLED) or an organic semiconductor material of an organic thin film transistor (OTFT).

The general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains. For example, the method illustrated in FIGS. 3 and 7 can be stored in the computer-recorded medium in a form of computer-readable codes to perform the method when the computer reads the computer-readable codes of the recording medium

As described above, according to the present general inventive concept, by adjusting the voltages applied to nozzles to normalize the mean thicknesses of ink layers formed by ink drops ejected from the nozzles, differences in ejection characteristics between the nozzles can be minimized. Thus, the amount of ink ejected from the nozzles can be made uniform, and ink layers having a uniform thickness can be formed in pixels of a color filter. Accordingly, the yield of color filters can be improved, and the filter performance can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A normalization method of ink drops to ensure uniformity of an amount of ink ejected from nozzles of an inkjet head, the normalization method comprising:
ejecting a predetermined number of ink drops from the nozzles into pixels according to a first voltage applied to the nozzles;
measuring mean thicknesses of ink layers formed in the pixels; and
setting a target thickness of the ink layers and applying a second voltage corresponding to the target thickness to each of the nozzles.

2. The normalization method of claim 1, wherein the mean thicknesses of the ink layers are measured using scanning white light interferometry (SWLI).

3. The normalization method of claim 2, wherein the SWLI measures the mean thicknesses of the ink layers using a mask in which measuring areas having the same size as the pixels are formed.

4. The normalization method of claim 1, wherein the mean thicknesses of the ink layers are measured using a stylus type surface profiler.

5. The normalization method of claim 1, wherein the first voltage varies according to a position of the pixels.

6. The normalization method of claim 1, wherein:
the nozzles move with respect to the pixels in a direction; and
the first voltage varies according to the position of the pixels in the direction.

7. The normalization method of claim 1, wherein:
the pixels comprise a plurality of rows of pixels; and
the ejecting of the predetermined number of ink drops comprises ejecting the predetermined number of ink drops in corresponding rows of pixels according to the first voltage.

8. The normalization method of claim 7, wherein:
the first voltage comprises a plurality of voltages; and
the ejecting of the predetermined number of ink drops comprises ejecting the predetermined number of ink drops in the corresponding rows of pixels according to corresponding ones of the plurality of first voltages.

9. The normalization method of claim 7, wherein:
the measuring mean thicknesses of ink layers comprises measuring the mean thicknesses of respective rows of the pixels; and
the applying of the second voltage comprises applying the second voltage according to the respective thicknesses.

10. The normalization method of claim 1, further comprising:
ejecting a second predetermined number of ink drops from the nozzles into the pixels according to the second voltage such that a uniform thickness is formed in the respective pixels.

11. The normalization method of claim 1, further comprising:
ejecting an amount of ink drops from the nozzles according to the second voltage.

12. A normalization method of ink drops to ensure uniformity of an amount of ink ejected from nozzles of an inkjet head, the normalization method comprising:
ejecting a predetermined number of ink drops from the nozzles onto predetermined locations on a base plate according to a first voltage applied to the nozzles;
measuring mean thicknesses of ink layers formed on the base plate; and
setting a target thickness of the ink layers and applying a second voltage corresponding to the target thickness to each of the nozzles.

13. The normalization method of claim 12, wherein the mean thicknesses of the ink layers are measured using scanning white light interferometry (SWLI).

14. The normalization method of claim 13, wherein the SWLI measures the mean thicknesses of the ink layers using a mask in which measuring areas having predetermined shape are formed.

15. The normalization method of claim 12, wherein the mean thicknesses of the ink layers are measured using a stylus type surface profiler.

16. The normalization method of claim 12, wherein the first voltage varies according to a position of the pixels.

17. The normalization method of claim 12, wherein:
the nozzles move with respect to the pixels in a direction; and
the first voltage varies according to the position of the pixels in the direction.

18. The normalization method of claim 12, wherein:
the pixels comprise a plurality of rows of pixels; and
the ejecting of the predetermined number of ink drops comprises ejecting the predetermined number of ink drops in corresponding rows of pixels according to the first voltage.

19. The normalization method of claim 18, wherein:
the first voltage comprises a plurality of voltages; and
the ejecting of the predetermined number of ink drops comprises ejecting the predetermined number of ink drops in the corresponding rows of pixels according to corresponding ones of the plurality of first voltages.

20. The normalization method of claim 18, wherein:
the measuring mean thicknesses of ink layers comprises measuring the mean thicknesses of respective rows of the pixels; and
the applying of the second voltage comprises applying the second voltage according to the respective thicknesses.

21. The normalization method of claim 12, further comprising:
ejecting a second predetermined number of ink drops from the nozzles into the pixels according to the second voltage such that a uniform thickness is formed in the respective pixels.

22. The normalization method of claim 12, further comprising:
ejecting an amount of ink drops from the nozzles according to the second voltage.

23. A computer-readable recording medium having embodied thereon a computer program to execute a normalization method of ink drops to ensure uniformity of an amount of ink ejected from nozzles of an inkjet head, the normalization method comprising:
ejecting a predetermined number of ink drops from the nozzles into pixels according to a first voltage applied to the nozzles;
measuring mean thicknesses of ink layers formed in the pixels; and
setting a target thickness of the ink layers and applying a second voltage corresponding to the target thickness to each of the nozzles.
